(19) United States
(12) Patent Application Publication
(10) Pub. No.: US 2007/0053583 A1
(43) Pub. Date: Mar. 8, 2007

(54) Image correcting apparatus, pattern inspection apparatus, and image correcting method, and reticle

(75) Inventor: Nobuyuki Harabe, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc., Kawasaki-shi (JP)

(21) Appl. No.: 11/298,608

(22) Filed: Dec. 12, 2005

(30) Foreign Application Priority Data
Sep. 8, 2005 (JP) 2005-260108

(51) Int. Cl. G06K 9/00

(52) U.S. Cl. 382/151

(57) ABSTRACT

A method and apparatus for appropriately correcting a displacement or a distortion between an optical image and a reference image or both the optical image and the reference image by using characteristics of a pattern of an object to be inspected are disclosed. An image correcting apparatus includes an optical image acquisition unit which acquires an optical image of an object to be inspected, a reference image creation unit which forms a reference image from design data, an image correcting unit which performs arithmetic processing to a correction model parameter and the reference image to correct the reference image and to form a corrected reference image, and a correction model parameter identifying unit which uses feature data based on characteristics of a pattern of the image of the object to be inspected to calculate the correction model parameter for correcting a displacement or a distortion between the optical image and the reference image or both the displacement and the distortion.

### CROSS-REFERENCE TO RELATED APPLICATION

This application is based upon and claims the benefit of prior Japanese Patent Application No. 2005-260108 filed on Sep. 8, 2005 in Japan, the entire contents of which are incorporated herein by reference.

### BACKGROUND OF THE INVENTION

### Field of the Invention

The present invention relates to pattern inspection for an object to be inspected such as a reticle, a reference image used in the pattern inspection, and a manufactured reticle. In particular, the present invention relates to pattern inspection for an object to be inspected used in manufacturing a semiconductor device or a liquid crystal display panel, a reference image used in the pattern inspection, and a manufactured reticle.

In processes of manufacturing a large-scale integrated circuit (LSI), a reduced projection exposure device (stepper) for transferring a circuit pattern uses a reticle (photomask) obtained by enlarging a circuit pattern 4 to 5 times as an original. Demands for completeness of the reticle, i.e., pattern precision, non-defectiveness, and the like are considerably increasing every year. In recent years, pattern transfer is performed at an approximate limiting resolution because of ultra-micropatterning and high-density integration, and a high-precision reticle is one of keys for manufacturing a device. Of these keys, improvement in performance of a pattern inspection for detecting a defect on an ultra-micropattern is necessary for improving short-term development and manufacturing yield of an advanced semiconductor device. In a pattern inspection of a high-precision reticle, a reference image similar to an optical image drawn on a reticle is formed from design data of the reticle, and the optical image is compared with the reference image to detect a defect of a pattern of the reticle. However, since a displacement or a distortion between the optical image and the reference image is generated, the displacement and the distortion need to be corrected. Therefore, a method is known in which an inspection precision is set for every pattern of a reticle to perform pattern inspection (see Japanese Patent Application, Publication No. 2004-191957)

### BRIEF SUMMARY OF THE INVENTION

(1) The present invention has an object to appropriately correct a displacement or a distortion between an optical image and a reference image or both the displacement and the distortion by using characteristics of a pattern of an object to be inspected.

(2) The present invention has another object to obtain an image correcting apparatus which can obtain a fine pattern, a pattern inspection apparatus, an image correcting method, or a reticle.

An image correcting apparatus according to an embodiment of the present invention includes: an optical image acquisition unit which acquires an optical image of an object to be inspected; a reference image creation unit which forms a reference image from design data of the object to be inspected; an image correcting unit which performs arithmetic processing to a correction model parameter and the reference image to correct the reference image and to form a corrected reference image; and a correction model parameter identifying unit which uses characteristic data based on characteristics of a pattern of the image of the object to be inspected to calculate the correction model parameter for correcting a displacement or a distortion between the optical image and the reference image or both the displacement and the distortion.

A pattern inspection apparatus according to an embodiment of the present invention includes: an optical image acquisition unit which acquires an optical image of an object to be inspected; a reference image creation unit which forms a reference image from design data; an image correcting unit which performs arithmetic processing to a correction model parameter and the reference image to correct the reference image and to form a corrected reference image; and a correction model parameter identifying unit which uses characteristic data based on characteristics of a pattern of the image of the object to be inspected to calculate the correction model parameter for correcting a displacement or a distortion between the optical image and the reference image or both the displacement and the distortion; and a comparing unit which compares the optical image with the corrected reference image.

An image correcting method according to an embodiment of the present invention includes: acquiring an optical image of an object to be inspected; forming a reference image from design data of the object to be inspected; performing arithmetic processing to a correction model parameter and the reference image to correct the reference image and to form a corrected reference image; and using characteristic data based on characteristics of a pattern of the image of the object to be inspected to calculate the correction model parameter for correcting a displacement or a distortion between the optical image and the reference image or both the displacement and the distortion.

A reticle according to an embodiment of the present invention undergoes a pattern inspection that uses characteristic data representing characteristics of a pattern of an image of the reticle to calculate a correction model parameter for correcting a displacement or a distortion between an optical image and a reference image or both the displacement and the distortion, performs arithmetic processing to the correction model parameter and the reference image to calculate a corrected reference image, and compares the optical image with the reference image.

### BRIEF DESCRIPTION OF THE SEVERAL VIEWS OF THE DRAWINGS

FIG. 1 is a block diagram of a reference image forming apparatus;

FIG. 2 is a conceptual diagram showing the configuration of a pattern inspection apparatus;

FIG. 3 is a diagram for explaining scanning of a pattern of a reticle;

FIG. 4 is a flow chart for forming a corrected reference image;

FIGS. 5A and 5B are diagrams for explaining characteristic data showing characteristics of a specific pattern; and

FIGS. 6A and 6B are diagrams for explaining characteristic data showing characteristics of another specific pattern.

### DETAILED DESCRIPTION OF THE PREFERRED EMBODIMENTS

A reference image forming apparatus, a pattern inspection apparatus, a reference image forming method, a pattern inspecting method, and a reticle according to an embodiment of the present invention will be described below.

(Pattern Inspection Apparatus)

A pattern inspection apparatus is to inspect a pattern formed on an object to be inspected such as a reticle to check whether the pattern is formed in a predetermined form. The pattern inspection apparatus includes an optical image acquisition unit and a data processor. The optical image acquisition unit reads a pattern drawn on an object to be inspected to obtain an optical image. The data processor is to perform control of the pattern inspection apparatus, e.g., the optical image acquisition unit, and data processing. The data processor has a reference image creation unit, correction model parameter identifying unit, and image correcting unit that form a reference image and corrects the reference image. The pattern inspection apparatus compares the obtained optical image with the reference image to inspect a defect or the like of an optical image drawn on an object to be inspected. In this case, the reference image is an image formed from design data of the object to be inspected such that the reference image is similar to the optical image.

The corrected reference image is a reference image which is obtained by correcting the reference image such that a displacement or a distortion between the optical image and the reference image or both the optical image and the reference image are eliminated. The design data is data for design serving as a base for drawing an image on the object to be inspected. Although a reticle will be described below as an object to be inspected, as the object to be inspected, any object on which a pattern is formed may be used, and a mask or a wafer may also be used.

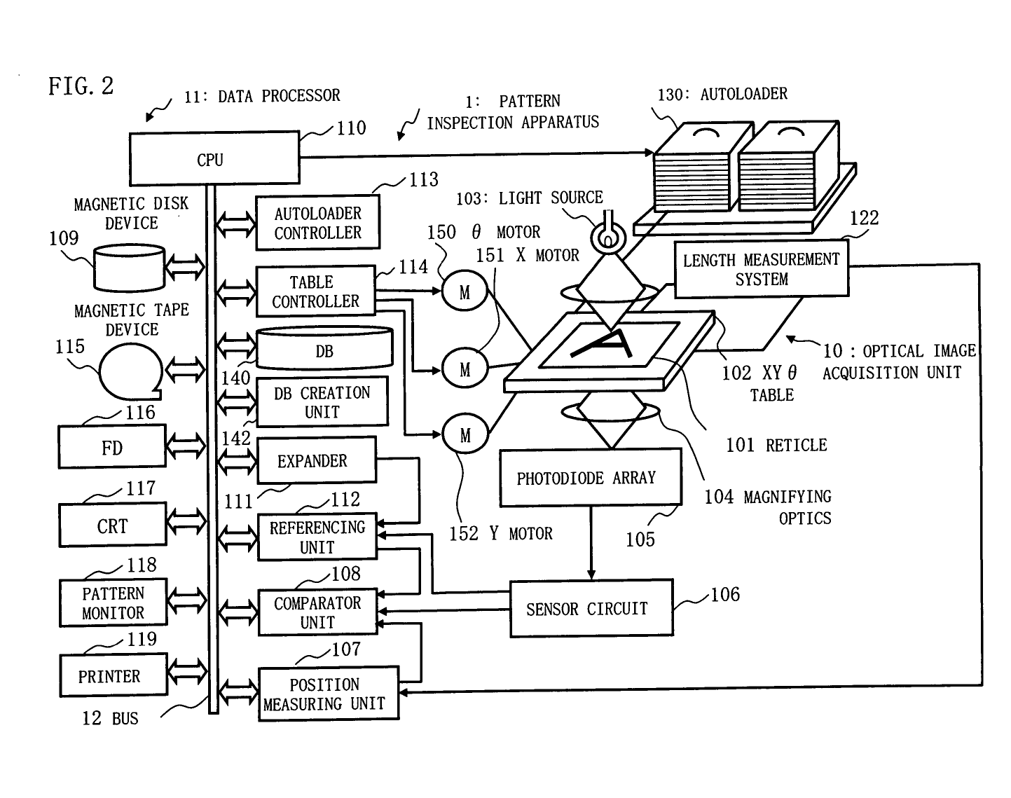

A pattern inspection apparatus 1, for example, as shown in FIG. 2, includes an optical image acquisition unit 10 and a data processor 11. The optical image acquisition unit 10 includes, as needed, an autoloader 130, a light source 103, XYθ table 102 on which a reticle 101 is placed, a θ motor 150, an X motor 151, a Y motor 152, a laser length measuring system 122, a magnifying optical system 104, a photodiode array 105, a sensor circuit 106, and the like. The data processor 11 includes, as needed, a central processing unit 110, a bus 12, an autoloader controller 113 which controls the autoloader 130 connected to the bus 12, a table controller 114 which controls the XYθ table 102, a database 140, a database maker 142, a expander 111, a referencing unit 112 which receives pattern data of design data from the expander 111 and receives an optical image from the sensor circuit 106, a comparing unit 108 which receives the optical image from the sensor circuit 106 and receives a corrected reference image from the referencing unit 112, a position measuring unit 107 which receives a position signal of the table 102 from the laser length measuring system 122, a magnetic disk device 109, a magnetic tape device 115, a FD 116, a CRT 117, a pattern monitor 118, a printer 119, and the like. The pattern inspection apparatus 1 is constituted by an electronic circuit, a program, or a combination thereof.

(Image Correcting Apparatus)

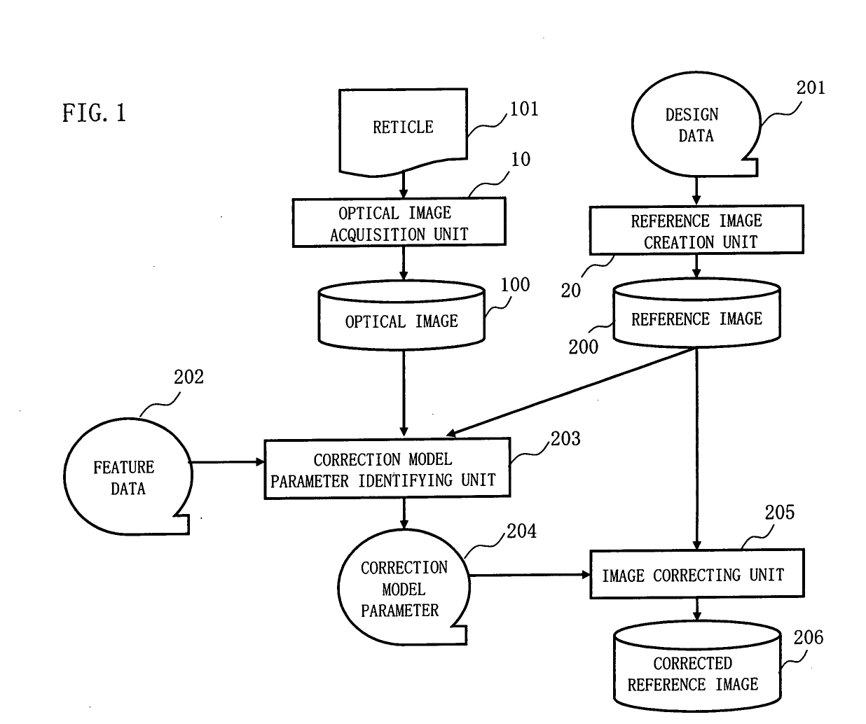

An image correcting apparatus is to form a corrected reference image similar to an optical image of a reticle such that a displacement or a distortion between the optical image and a reference image or both the displacement and the distortion are eliminated. The image correcting apparatus has, for example, as shown in FIG. 1, an optical image acquisition unit 10, a reference image creation unit 20, a correction model parameter identifying unit 203, and an image correcting unit 205. The correction model parameter identifying unit 203 uses an optical image 100 obtained by the optical image acquisition unit 10, characteristic data 202 representing characteristics of a pattern of a reticle, and a reference image 200 formed by the reference image creation unit 20 to form a correction model parameter 204. The image correcting unit 205 causes the correction model parameter 204 obtained by the correction model parameter identifying unit 203 to act on the reference image 200 and performs arithmetic processing to form a corrected reference image 206. The image correcting apparatus can be constituted by an electronic circuit, a program, or a combination thereof.

The characteristic data 202 used here is to designate a specific pattern of an image of a reticle, and indicate characteristic portions of the image of the reticle. The characteristic data is identification data which is formed when an image of a reticle is designed, corresponds to a pattern position of the reticle, and designates a pattern. The characteristic data is, for example, expressed by an image in association with the image of the reticle and constituted by data of a pixel value. The characteristic data can give a weight to the pattern of the image of the reticle. The characteristic data indicates a pattern desired to be drawn at high precision, an assistant pattern, a dummy pattern, or the like. As a pattern used in the embodiment, a pattern having any shape may be used. For example, an independent pattern, a pattern obtained by combining independent patterns, a portion (part) of an independent pattern, or a portion (part) of a combined pattern may be used.

(Optical Image Acquisition Unit)

The optical image acquisition unit 10 acquires an optical image of the reticle 101. The reticle 101 serving as a sample to be inspected is placed on the XYθ table 102. The XYθ table 102 is controlled by motors 151, 152, and 150 of X, Y, and θ axes in accordance with a command from the table controller 114 such that the XYθ table 102 moves in a horizontal direction or a rotating direction. Light from the light source 103 is irradiated on a pattern formed on the reticle 101. Light transmitted through the reticle 101 is focused as an optical image on the photodiode array 105 through the magnifying optical system 104. An image fetched by the photodiode array 105 is processed by the sensor circuit 106, and serves as data of an optical image to be compared with a corrected reference image.

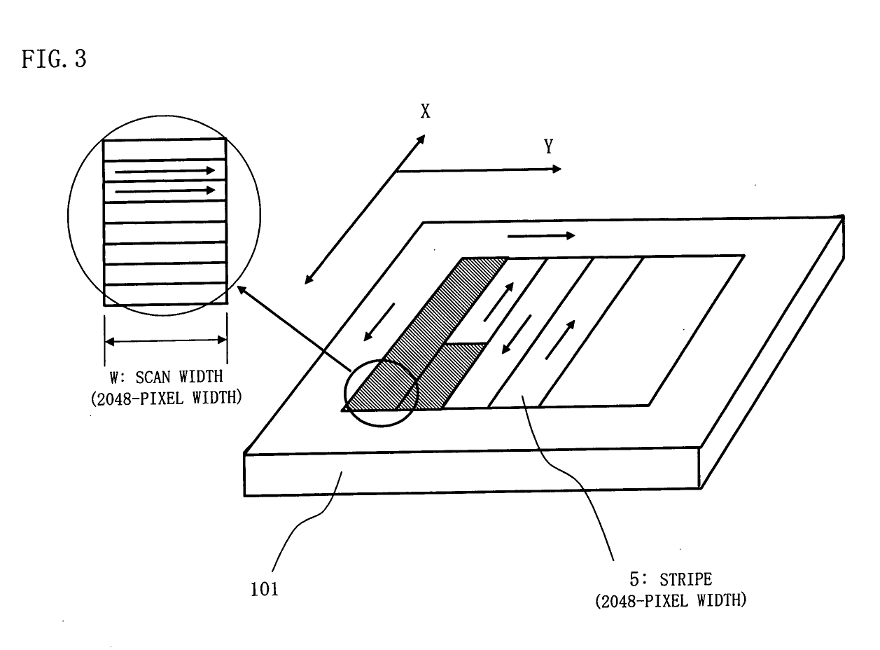

A procedure for acquiring an optical image will be described below with reference to FIG. 3. A region to be inspected on the reticle 101 is, as shown in FIG. 3, virtually divided into a plurality of strip-like inspection stripes 5 each having a scanning width W in a Y direction. The divided inspection stripes 5 are continuously scanned. For this purpose, the XYθ table 102 moves in an X direction under the control of the table controller 114. In accordance with the movement, optical images of the inspection stripes 5 are acquired by the photodiode array 105. The photodiode array 105 continuously acquires the images each having a scanning width W. After the photodiode array 105 acquires the image of the first inspection stripe 5, the photodiode array 105 continuously acquires the image of the second inspection stripe 5 in the scanning width W by the same method as described above though in a direction opposing the scanning direction of the first inspection stripe 5. The image of the third inspection stripe 5 is acquired in a direction opposing the direction for acquiring the image of the second inspection stripe 5, i.e., in the direction for acquiring the image of the first inspection stripe 5. In this manner, the images are continuously acquired to shorten wasteful processing time. In this case, for example, the scanning width W is made 2048 pixels.

The image of the pattern formed on the photodiode array 105 is photoelectrically converted by the photodiode array 105, and then A/D (analog/digital)-converted by the sensor circuit 106. The light source 103, the magnifying optical system 104, the photodiode array 105, and the sensor circuit 106 constitute a high-power inspection optical system.

The XYθ table 102 is driven by the table controller 114 under the control of the central processing unit 110. A moving position of the XYθ table 102 is measured by the laser length measuring system 122, and the resultant measured value is transmitted to the position measuring unit 107. The reticle 101 on the XYθ table 102 is carried from the autoloader 130 under the control of the autoloader controller 113. Measured pattern data of the inspection stripes 5 output from the sensor circuit 106 is transmitted to the referencing unit 112 and the comparing unit 108 together with the data which represents a position of the reticle 101 on the XYθ table 102 and is output from the position measuring unit 107. The data of the optical image and the data of the corrected reference image to be compared are cut into areas each having an appropriate pixel size. For example the data are cut into regions each having 512×512 pixels.

(Reference Image Creation Unit)

The reference image creation unit 20 is to form a reference image to be corrected. The reference image creation unit 20 forms a reference image serving as an image similar to an optical image from design data of a reticle to be inspected. The reference image creation unit 20 performs various conversions to the design data to form a reference image. The reference image creation unit 20 can be constituted by a expander 111 and a referencing unit 112. The expander 111 reads design data of an image of the reticle from a magnetic tape device 115 through a central processing unit 110 and converts the design data into image data. The referencing unit 112 receives the image data from the expander 111 and performs a process of making the image similar to the optical image by rounding the corners of a graphic or causing the graphic to slightly blur, so that a reference image is formed.

(Correction Model Parameter Identifying Unit)

The correction model parameter identifying unit 203 is to calculate a correction model parameter. The correction model parameter is to eliminate a displacement or a distortion between the optical image 100 and the reference image 200 or both the displacement and the distortion. The correction model parameter acts on the reference image 200 to convert the reference image 200 into the corrected reference image 206. The correction model parameter also serves as a filter to eliminate the displacement or the distortion or both the displacement and the distortion. The correction model parameter is calculated by feature data according to the characteristics of a pattern of the reticle. The correction model parameter is calculated according to the characteristics of the pattern such that a weight is given to an image position of the pattern of the reticle by the feature data. The correction model parameter is caused to act on the reference image 200 to calculate the corrected reference image 206. For example, the corrected reference image 206 is calculated by Equation 1. In this equation, Iref(x) indicates the reference image 200, Icor(x) indicates the corrected reference image 206, and g(x) indicates the correction model parameter. In Equation 1, a convolution operation between the correction model parameter g(x) and the reference image Iref(x) is performed to calculate a corrected reference image Icor(x). In this case, the reference image and the corrected reference image are image data constituted by a grayscale such as a luminance in each pixel (x). The correction model parameter g(x) is also data having a value in each pixel (x). The correction model parameter may also be handled as a fixed parameter group independent of a position x.
Icor(x)=g(x) [symbol] Iref(x) [Equation 1]

The correction model parameter g(x) is calculated by using feature data based on characteristics of a pattern of an image of a reticle such that a displacement or a distortion between an optical image and a reference image or both the displacement and the distortion are corrected. More specifically, the correction model parameter g(x) is calculated such that a sum of values obtained by multiplying a difference between the optical image and the corrected reference image by weights of the feature data is minimized. For example, the correction model parameter g(x) is calculated by minimizing a sum ≢ of Equation 2. In this equation, Iscn(x) indicates an optical image, and w(x) indicates feature data which means a weight of a specific pattern. The optical image is image data constituted by a grayscale such as a luminance in each pixel (x).
Δ=Σ{w(x)×|Iscn(x)−Icor(x)|} [Equation 2]

The feature data weights positions of pixels depending on the characteristics of the patterns of the reticle. In this manner, according to Equation 2, a total sum of pixels of the difference between the images of the reticle is calculated, and the correction model parameter is calculated such that the total sum is minimized. In this manner, the correction model parameters depending on the degrees of importance of the pixels of the patterns can be formed. The correction model parameter identifying unit 203 can be arranged in the referencing unit 112 in FIG. 2, for example.

(Image Correcting Apparatus)

In the image correcting apparatus, a weight is given to a specific pattern depending on feature data, a correction model parameter obtained by giving the weight to the specific pattern is caused to act on a reference image, and arithmetic processing is performed to form a corrected reference image. In the image correcting apparatus, for example, according to Equation 1, a correction model parameter identified by the correction model parameter identifying unit is caused to act on the reference image to form the corrected reference image. The image correcting unit 205 can be arranged in the referencing unit 112 in FIG. 2, for example.

(Image Correcting Method)

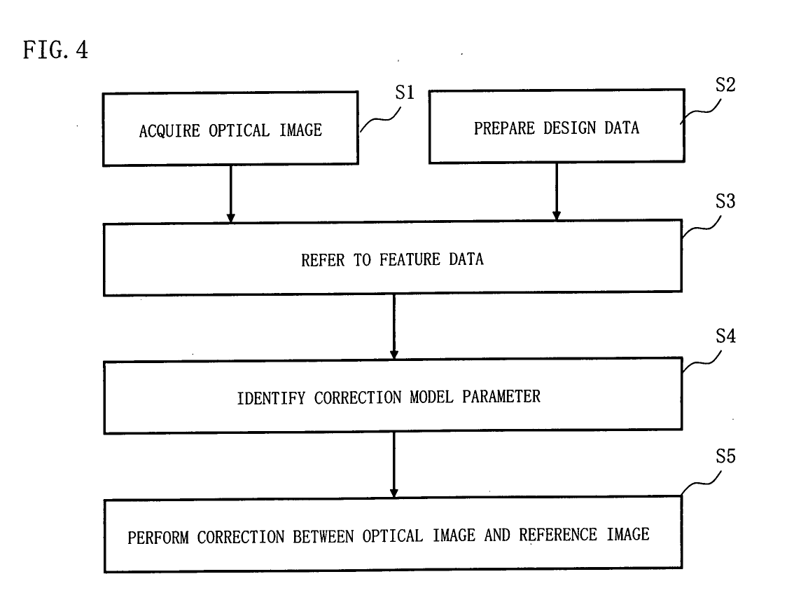

The image correcting method is performed in steps as shown in FIG. 4. In step S1, an optical image drawn on a reticle is acquired. In step S2, a reference image is formed from design data of an image of the reticle. In step S3, feature data representing characteristics of a pattern of the image of the reticle is referred to. In step S4, a correction model parameter is calculated by using the feature data. In step S5, the correction model parameter is caused to act on a reference image to form a corrected reference image. The corrected reference image is compared with the optical image to inspect the pattern, so that the images from which a displacement or a distortion or both the displacement and the distortion are eliminated can be compared.

(Pattern Inspecting Method)

The pattern inspecting method is a method which compares a corrected reference image obtained by the image correcting method by using feature data corresponding to a more specific pattern with an optical image of a reticle to inspect patterns of a reticle. As a result, pattern inspection of the reticle can be more appropriately and accurately performed.

(Inspected Reticle)

A reticle is drawn by a drawing device using design data. The formed reticle is inspected by a pattern inspection apparatus with respect to an optical image. In this case, pattern inspection is performed by comparing the optical image with the corrected reference image. The corrected reference image is calculated by performing arithmetic processing between a correction model parameter and the reference data. The correction model parameter is calculated by using the feature data such that a displacement or a distortion between the optical image and the reference image or both the displacement and the distortion are corrected. For example, the correction model parameter is calculated such that a sum of values obtained by multiplying a difference between the optical image and the corrected reference image by weights of the feature data is minimized.

### First Embodiment

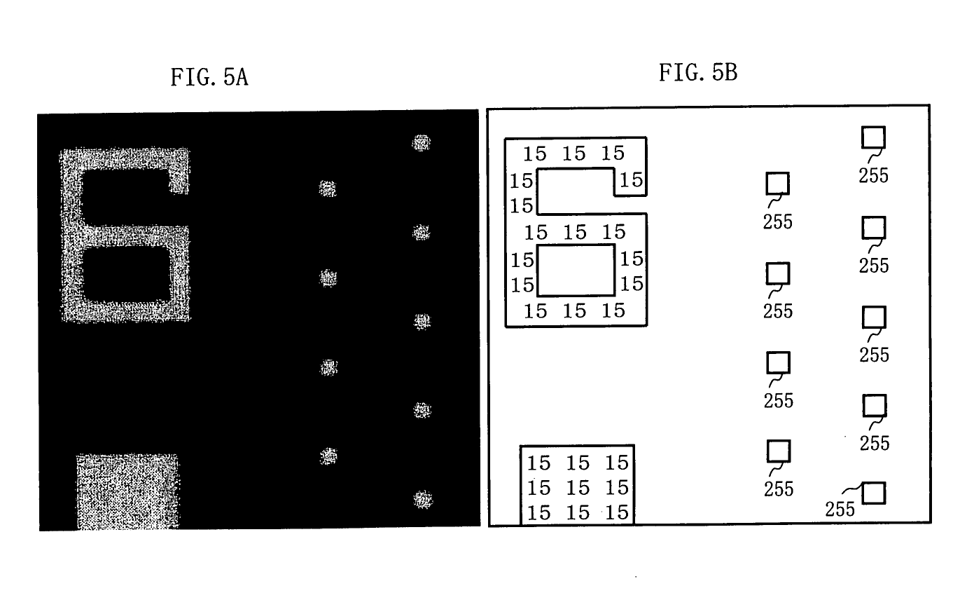

A portion of a specific pattern according to a first embodiment of the present invention is shown in FIG. 5A. Feature data corresponding to the portion is shown in FIG. 5B as image data. A white-dot-like hole on the right side of FIG. 5A, for example, a pattern of a contact hole, is a pattern having high drawing precision. Feature data in FIG. 5B corresponds to an image position of a pattern of a hole and indicates a value of 255. The feature data is expressed by an image and represented by a pixel value. In this example, the value of the feature data falls within the range of, e.g., 0 to 255, for example.

A white pattern on the left side of FIG. 5A is a pattern having a low drawing precision, for example, a dummy pattern. FIG. 5B corresponds to an image position of the dummy pattern and shows a value of 15. The weight w(x) is defined by dividing a value (pixel value) of feature data by 255 and a real number falling within 0≦w(x)≦1. The value of the weight w(x) is assigned to w(x) in Equation 2 to calculate a correction model parameter g(x). The correction model parameter g(x) is assigned to g(x) in Equation 1 to calculate a corrected reference image. In this manner, feature data of a large pixel value is given to a specific pattern required to be formed at a high precision, and feature data of a small pixel value is given to a pattern not required to be formed at a high precision. The feature data are used to make it possible to appropriately correct a displacement or a distortion between the optical image and the reference image or both the displacement and the distortion with a focus on an important pattern portion of the reticle.

### Second Embodiment

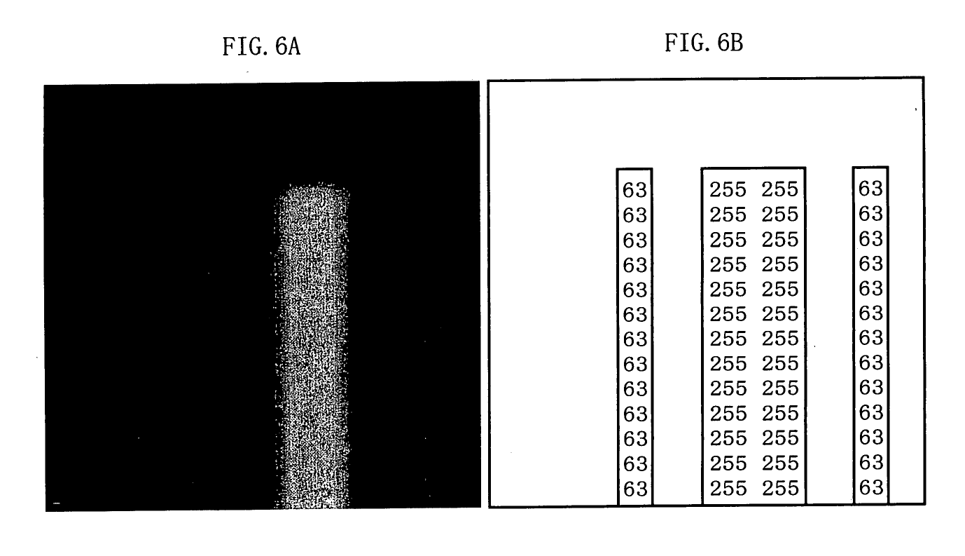

A specific pattern portion according to a second embodiment of the present invention is shown in FIG. 6A. Feature data corresponding to the pattern portion is shown in FIG. 6B as image data. A white wide-strip-shaped pattern is a pattern having a high drawing precision, and narrow-strip-shaped patterns on both the sides of the wide-strip-shaped pattern are patterns not required to be formed at a high precision, for example, an assistant pattern. Feature data of the pattern having the high drawing precision in FIG. 6A is shown as a value of 255. Feature data of the assistant pattern in FIG. 6A is shown as a value of 63. The feature data of the assistant pattern is larger than the dummy pattern in FIG. 5. In this manner, different degrees of importance can be given to different patterns by feature data, respectively. The weight of the feature data is calculated by dividing a pixel value of the auxiliary data by 255 as in the first embodiment.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image correcting apparatus comprising:
an optical image acquisition unit which acquires an optical image of an object to be inspected;
a reference image creation unit which forms a reference image from design data of the object to be inspected;
an image correcting unit which performs arithmetic processing to a correction model parameter and the reference image to correct the reference image and to form a corrected reference image; and
a correction model parameter identifying unit which uses feature data based on characteristics of a pattern of the image of the object to be inspected to calculate the correction model parameter for correcting a displacement or a distortion between the optical image and the reference image or both the displacement and the distortion.

2. The image correcting apparatus according to claim 1, wherein
the feature data is a weight given to a pattern, and
the correction model parameter identifying unit calculates a sum obtained by multiplying a difference between the optical image and the corrected reference image by the weights of the feature data and determines the correction model parameter such that the sum is minimized.

3. A pattern inspection apparatus comprising:
an optical image acquisition unit which acquires an optical image of an object to be inspected;
a reference image creation unit which forms a reference image from design data;
an image correcting unit which performs arithmetic processing to a correction model parameter and the reference image to correct the reference image and to form a corrected reference image; and
a correction model parameter identifying unit which uses feature data based on characteristics of a pattern of the image of the object to be inspected to calculate the correction model parameter for correcting a displacement or a distortion between the optical image and the reference image or both the displacement and the distortion; and
a comparing unit which compares the optical image with the corrected reference image.

4. The pattern inspection apparatus according to claim 3, wherein
the feature data is a weight given to a pattern, and
the correction model parameter identifying unit calculates a sum obtained by multiplying a difference between the optical image and the corrected reference image by the weights of the feature data and determines the correction model parameter such that the sum is minimized.

5. An image correcting method comprising:
acquiring an optical image of an object to be inspected;
forming a reference image from design data of the object to be inspected;
performing arithmetic processing to a correction model parameter and the reference image to correct the reference image and to form a corrected reference image; and
using feature data based on characteristics of a pattern of the image of the object to be inspected to calculate the correction model parameter for correcting a displacement or a distortion between the optical image and the reference image or both the displacement and the distortion.

6. The image correcting method according to claim 5, wherein
the feature data is a weight given to a pattern, and
the correction model parameter is calculated such that a sum obtained by multiplying a difference between the optical image and the corrected reference image by the weights of the feature data is minimized.

7. The image correcting method according to claim 5, wherein
a weight of the feature data with respect to a pattern having a high drawing precision is increased.

8. The image correcting method according to claim 5, wherein
a weight of the feature data with respect to an assistant pattern is decreased.

9. The image correcting method according to claim 5, wherein
a weight of the feature data with respect to a dummy pattern is decreased.

10. A reticle which undergoes a pattern inspection that uses feature data representing characteristics of a pattern of an image of the reticle to calculate a correction model parameter for correcting a displacement or a distortion between an optical image and a reference image or both the displacement and the distortion, performs arithmetic processing to the correction model parameter and the reference image to calculate a corrected reference image, and compares the optical image with the reference image.

11. The reticle according to claim 10, wherein
the feature data is a weight given to the pattern, and
the correction model parameter is calculated such that a sum obtained by multiplying a difference between the optical image and the corrected reference image by the weights of the feature data is minimized.
